(19) United States
(12) Patent Application Publication
(10) Pub. No.: US 2026/0158400 A1
(43) Pub. Date: Jun. 11, 2026

(54) EDUCATIONAL PLUSH

(71) Applicant: Pamela Salmon, Colts Neck, NY (US)

(72) Inventor: Pamela Salmon, Colts Neck, NY (US)

(21) Appl. No.: 19/346,707

(22) Filed: Oct. 1, 2025

Related U.S. Application Data
(60) Provisional application No. 63/720,878, filed on Nov. 15, 2024.
(60) Provisional application No. 63/766,739, filed on Mar. 4, 2025.

(51) Int. Cl. A63H 3/00; A63H 3/02; A63H 3/28; A63H 3/36; G09B 5/04; G09B 19/00

(52) U.S. Cl. CPC A63H 3/003; A63H 3/02; A63H 3/28; A63H 3/36; G09B 19/0076; G09B 5/04

(57) ABSTRACT

An educational plush toy is disclosed. The educational plush toy comprises a body portion comprises at least two arms, each arm terminating to at least one paw; a first attachment element positioned on each of the at least one paw; at least one message card configured to be detachably attached to the at least one paw via the first attachment element, the at least one message card includes a visual affirmation; at least one mirror card configured to be detachably attached to another of the at least one paw via the first attachment element, the at least one mirror card including a reflective surface. The educational plush toy is constructed and arranged such that the user is enabled to view their own reflection in the reflective surface of the at least one mirror card while reading or hearing the visual affirmation displayed over the plurality of cards.

### CROSS-REFERENCE TO RELATED APPLICATION

This application claims the priority benefit of provisional patent application Ser. No. 63/720,878, filed Nov. 15, 2024 and provisional patent application Ser. No. 63/766,739, filed Mar. 4, 2025 by the present inventor, which is incorporated herein by reference in its entirety.

### FIELD OF THE DISCLOSURE

This application is directed to child emotional development and training using plushes and cards. In particular, the application is directed to soothing and managing child emotions by reinforcing habits of happiness through emotional mirroring techniques implementable by a user using posable plush, cards, and a mirror.

### BACKGROUND OF THE DISCLOSURE

Plushes (i.e., dolls filled with stuffing) have been used in various aspects to aid in the emotional development of children. For instance, Kaplan Early Learning Company's “Emotion Bears” are plush dolls with matching blankets that encourages social emotional development. The plushes, in the form of four bears, are intended to help children identify and label the common emotions of happy, sad, angry, and scared by having children match the bear to the corresponding color on the blanket, and then discussing each emotion presented. However, the Emotion Bears do not provide visual feedback to the child of the emotion being expressed on their faces.

Yet another tool, Kaplan Early Learning Company's “Open to Emotion Backpack Kit”, for aiding in the emotional development of children includes a set of teaching cards and a hand-held mirror. The tool is aimed at providing a tactile and visual way of introducing young children to emotions. Further, the tool is aimed at providing children a means to strengthen their expressive and receptive language as they learn to talk about feelings and emotions using a stuffing-filled mirror. The prior art, however, does not use a plush doll configured to receive an attachable/detachable mirror and/or cards for aiding in child emotional development.

Hence, there remains a need for providing plushes that can be configurable with a card and a mirror offering a variety of possible teaching opportunities for children. The potential teaching opportunities can take advantage of the ability to position groups of plushes in a manner that can provide communicative information to the users and/or children using cards having emotional affirmations written thereon and mirrors reflecting to the child her synchronic image.

### SUMMARY OF THE DISCLOSURE

The way your child thinks and the words they use to see themselves in the world have the power to shape their happiness. It is an object of the present disclosure to provide comforting plush designed to help children develop positive thinking habits through emotional mirroring techniques. Further, the plush is a comforting companion that teaches kids how to navigate their emotions with confidence and joy.

Briefly described, a plush with cards and mirror and an educational system using the plush and accompanying card and mirror are set forth herein. The plush provides emotional wellness allowing children (with or without the assistance of an adult) to explore and express their feelings through emotional mirroring techniques using cards and a mirror.

In an aspect, the disclosure is a plush. The plush, comprising paws (including an attachment means—e.g., Velcro) configured on the arms of the plush, is constructed to hold a card and/or mirror thereon, said card and mirror themselves including an attachment means such as Velcro. The plush is adapted to enable a child to look into the mirror (in the form of a card affixed to one paw of the plush) and read, or have read to her, affirmations written on a card affixed to another paw of the plush.

In another aspect, the plush may be presented for use with or without accompanying card and/or mirror wherein features of the plush provide emotional support to the child. Further, the plush may be fashioned to be posable allowing the plush to be shaped in various positions. In yet another aspect, the plush may be comprised of a plurality of plushes affixed together at the paws.

Further, it is understood that the present disclosure uses plush and plushes interchangeable unless expressly indicated otherwise.

Another aspect of the disclosure is an educational system. The educational system comprising one or more plushes, including cards and/or mirrors, wherein when the plush is opposingly presented to the child allows the child to read (or have read) the card affixed to a paw of the plush while seeing themselves in the mirrored card, together allowing the child to see, say, and express an emotion.

Still yet another aspect of the disclosure is an educational method. The educational method comprising one or more plushes affixed with cards and/or mirrors wherein the child is presented with the plush and looks into the mirrored card while saying the affirmation displayed on the other card thereby reinforcing positive thoughts through use of emotional mirroring techniques.

In one embodiment of the present disclosure, an educational plush toy for emotional wellness of a user is disclosed. The educational plush toy comprises a body portion that comprises at least two arms, each arm terminating to at least one paw. Further, the body portion comprises a first attachment element positioned on each of the at least one paw. Further, the educational plush toy comprises at least one message card configured to be detachably attached to the at least one paw of an arm from the at least two arms via the first attachment element, the at least one message card including a visual affirmation. Further, the educational plush toy comprises at least one mirror card configured to be detachably attached to at least one paw of another arm of the at least two arms via the first attachment element, the at least one mirror card including a reflective surface. In one embodiment, the educational plush toy is constructed and arranged such that the user is enabled to view their own reflection in the reflective surface of the at least one mirror card while reading or hearing the visual affirmation displayed over the at least one message card.

In one embodiment, each of the at least one message card and the at least one mirror card comprises a second attachment element configured to detachably attach with a corresponding first attachment element to detachably attach the at least one message card and the at least one mirror card to the at least one paw of the corresponding arm. The first attachment element and the second attachment elements correspond to at least one of a Velcro, magnets, snaps, or other reusable fastening elements.

In one embodiment, the at least one message card comprises a first side and a second side, wherein the first side indicates a positive character image and text for illustrating various behaviors to the user, and the second side indicates the visual affirmation and instructional guidance to be practiced by the user.

In one embodiment, the visual affirmation comprises positive, emotionally supportive statements to promote self-awareness, emotional expression, and psychological well-being to the user.

In one embodiment, the educational plush toy comprises a face portion coupled to the body portion, the face portion includes a facial expression indicator configured to represent one or more emotions to the user, wherein the one or more emotions comprises at least one of a peace, love, and happiness.

In one embodiment, the education plush toy is configured to detachably couple in a series to another one or more education plush toys by detachably attaching the first attachment element with a corresponding attachment element on each of the one or more education plush toys.

In one embodiment, the body portion further comprises one or more sensors integrated within a plurality of locations of the body portion, each of the one or more sensors are configured to detect a touch input of the user. The body portion further comprises at least one speaker operatively coupled to each of the one or more sensor, wherein the at least one speaker is configured to provide an audio feedback or interactive response to the user based at least on the detected touch input.

In one embodiment, the educational plush toy comprises one or more accessories configured to be removably attached to the at least one paw, the one or more accessories are configured to teach health and hygiene, environmental awareness, safety skills, language learning, and storytelling to the user.

In another embodiment, a method for emotional wellness of a user is disclosed, the method comprises steps of attaching at least one message card removably to at least one paw of an arm from at least two arms via the first attachment element, the at least one message card including a visual affirmation, and each arm termination to the at least one paw; and attaching at least one mirror card detachably to at least one paw of another arm of the at least two arms via the first attachment element, wherein the at least one mirror card including a reflective surface, the educational plush toy is constructed and arranged such that the user is enabled to view their own reflection in the reflective surface of the at least one mirror card while reading or hearing the visual affirmation displayed over the at least one message card.

### BRIEF DESCRIPTION OF THE DRAWINGS

Various embodiments of the present disclosure can be more readily understood and appreciated from the following descriptions of various embodiments of the present disclosure when read in conjunction with the accompanying drawings, in which:

FIG. 1A shows a frontal image of an educational plush toy, according to an embodiment of the present disclosure;

FIG. 1B shows a frontal image of an educational plush toy, according to another embodiment of the present disclosure;

FIGS. 2A-2C show a front and back view of at least one message card, according to an embodiment of the present disclosure;

FIGS. 3A-3C show a frontal image of the educational plush toy affixed with at least one message card and at least one mirror card, according to an embodiment of the present disclosure;

FIGS. 4A-5 show how the user or child may combine teachings of peace, love, and kindness by attaching the educational plush toy with another educational plush toys of different designs, according to an embodiment of the present disclosure;

FIG. 6 illustrates a user engaging with a child using an exemplary plush system, according to an embodiment of the present disclosure;

FIGS. 7A-7B show a frame for the educational plush toy, according to an embodiment of the present disclosure;

FIG. 8 illustrates a block diagram showing communication between one or more sensors and at least one speaker, according to an embodiment of the present disclosure; and

FIG. 9 shows a flowchart showing a method for providing emotional wellness to the user, according to an embodiment of the present disclosure.

### DETAILED DESCRIPTION

To facilitate an understanding of embodiments, principles, and features of the present disclosure, they are disclosed hereinafter with reference to implementation in illustrative embodiments. Embodiments of the present disclosure, however, are not limited to use in the described treatments or methods and may be utilized in other treatments and methods as will be understood by those skilled in the art familiar with this disclosure.

The components described hereinafter as making up the various embodiments are intended to be illustrative and not restrictive. Many suitable components that would perform the same or a similar function as the components described herein are intended to be embraced within the scope of embodiments of the present disclosure.

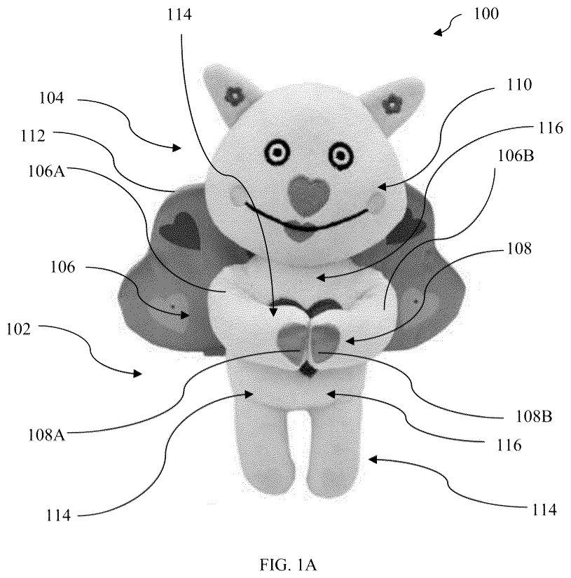

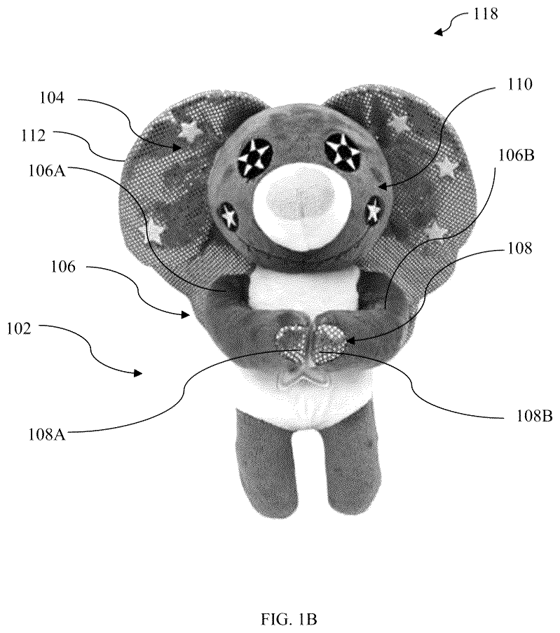

FIGS. 1A and 1B, show a frontal image of an educational plush toy 100 for emotional wellness of a user, according to an embodiment of the present disclosure.

In some embodiments, the educational plush toy 100 is configured to provides emotional wellness to the user. In one example embodiment, the user corresponds to a child. In some embodiments, the educational plush toy 100 may serve as an emotionally supportive companion for the child by facilitating self-expression, emotional regulation, and self-smoothening. In some embodiments, the educational plush toy 100 is configured to promote emotional wellness through interactive and reflective components that will be described further. In some embodiments, the educational plush toy 100 may be constructed from soft, child-safe materials suitable for prolonged physical interaction and emotional comfort. In some embodiments, the materials may comprise at least one of a textile fabric such as polyester cotton, fleece, or a blend thereof.

In some embodiments, the educational plush toy 100 may be filled with compressible and resilient stuffing material. In some embodiments, the stuffing material may comprise at least one of a polyester fiberfill, foam beads, or other suitable cushioning substances that allow the educational plush toy 100 to maintain its shape while remaining huggable and pliable. In some embodiments, the educational plush toy 100 may comprise at least a body portion 102 and a face portion 104. In some embodiments, the body portion 102 of the educational plush toy 100 corresponds and forms main structure of the educational plush toy 100 that provide shape, support and attachment areas for other components. Further, the face portion 104 corresponds to a section of the educational plush toy 100 that visually represents facial features and may be used to convey expressions or emotions to the user.

In some embodiments, the body portion 102 comprises at least two arms 106. In some embodiments, each arm of the at least two arms 106 further terminates into at least one paw 108. In some embodiments, the at least two arms 106 may correspond to an arm 106A and another arm 106B that are configured to resemble limbs of the educational plush toy 100. Further, the arm 106A may have at least one paw 108A and the another arm 106B may have at least one paw 108B. Further, the body portion 102 comprises a first attachment unit positioned on each of the at least one paw 108. In some embodiments, the first attachment element corresponds to at least one of a Velcro, magnets, snaps, or other reusable fastening elements. In some embodiments, the first attachment unit is configured to detachably connect external components to the body portion 102 of the educational plush toy 100 and allow flexible interaction and customization, enabling various educational or therapeutic components to be securely affixed to the educational plush toy 100.

In some embodiments, the face portion 104 includes a facial expression indicator 110 configured to represent one or more emotions to the user. In some embodiments, the one or more emotions comprises at least one of a peace, love, and kindness. In some embodiments, the facial expression indicator 110 may be permanently integrated to the face portion 104 of the educational plush toy 100. In some embodiments, the facial expression indicator 110 may be implemented through a variety of means including at least one of embroidery, printed graphics, fabric overlays, sewn-in patterns, or attachable features including Velcro-backed facial components (not shown). In some embodiments, the emotion “Peace” may be represented with closed or gentle curved eyes and neutral or slight smile to suggest calm and relaxation. Peace is a calming feeling we can all sense. It takes the time to understand why someone is acting a certain way and Peace never raises their voice. Peace is thoughtful, always choosing kind and calm words before speaking, and shows care by smiling and laughing with others.

Further, the emotion “Love” may be shown by using heart shape, as shown in FIG. 1A. Love seeks to bring comfort and calm to others, it teaches us to love ourselves by showing kindness and understanding, helping us care for both ourselves and those around us. Love builds lifelong friendships because it reminds us that none of us are perfect. Further, the emotion “kindness” may be shown through open, circular eyes with stars in the eyes and the body portion 102, as shown in FIG. 1B of the educational plush toy 118. Kindness is about being thoughtful and caring for other children's feelings. It means being friendly, compassionate, and doing nice things for others without expecting anything in return. Kindness also shows in small acts, like holding the door open for others and thanking those who do the same. Further, the educational plush toy 100 may comprise at least two wings 112 attached to a back portion to signify and amplify the one or more emotions. In one example, the at least two wings 112 may comprise heart shapes.

The plush includes arms, each arm with a paw, wherein the paw is constructed with attachment means such as Velcro. The attachment means facilitates attaching separate plush to each other as well as attaching cards and/or mirrored cards to the one or more plushes.

In some embodiments, the educational plush toy 100 further comprises one or more sensors (not shown) integrated within a plurality of locations (as shown by arrows 114) of the body portion 102, each of the one or more sensors are configured to detect a touch input of the user. In some embodiments, the one or more sensors comprises at least one of a touch sensor, pressure sensor, resistive touch sensor pads or other suitable sensor capable of identifying physical interaction with the educational plush toy 100. In some embodiments, placement of the one or more sensors may vary depending on the design and intended interaction zones of the educational plush toy 100 and the plurality of locations may include at least the paws, belly, back, or head. The integration of the one or more sensors enables the educational plush toy 100 to respond dynamically to the user engagement, promoting interactive learning.

Further, the body portion 102 further comprises at least one speaker (not shown) integrated within the plurality of locations as shown by arrows 116 and operatively coupled to each of the one or more sensors, the at least one speaker is configured to provide an audio feedback or interactive response to the user based at least on the detected touch input. In some embodiments, the plurality of locations may include at least the paws, belly, back, or head. In one example embodiment, when the user touches a designated sensor of the one or more sensors, the at least one speaker may play a prerecorded affirmation, comforting phrase, language-learning cue, or instructional prompt. The prerecorded affirmation may be incorporated with different languages to teach basic vocabulary.

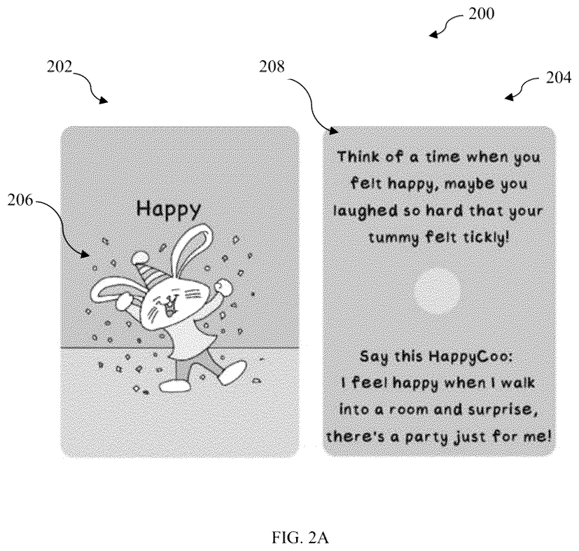

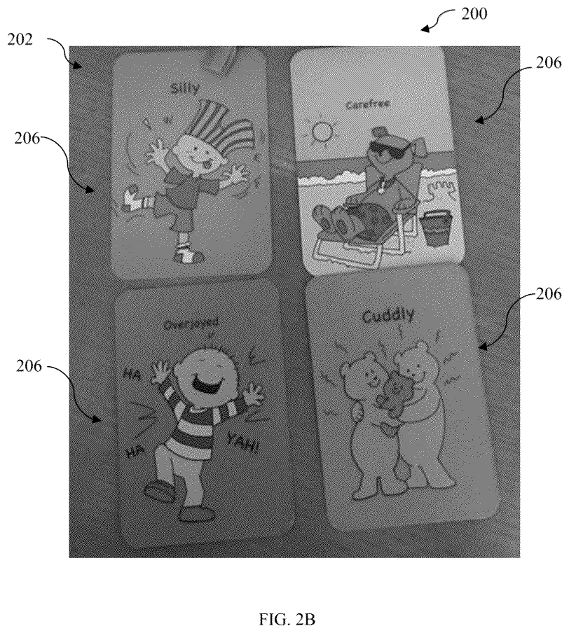

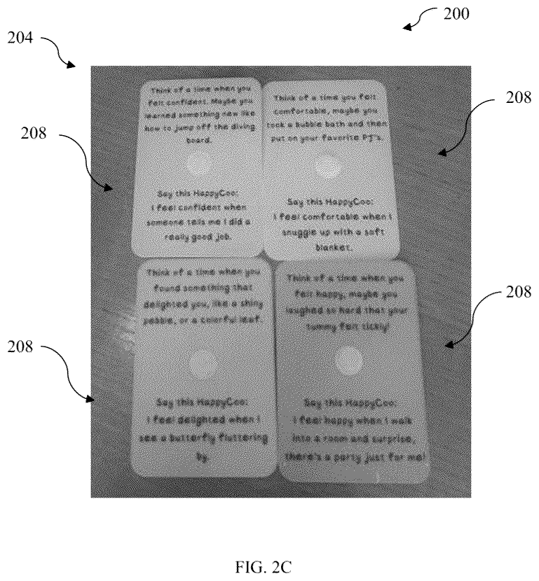

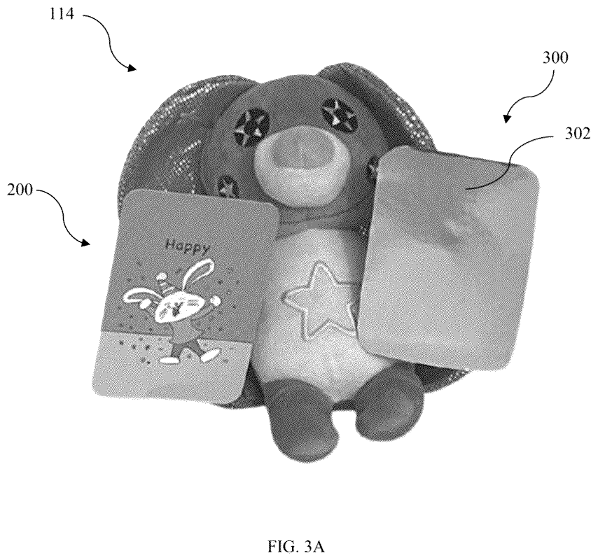

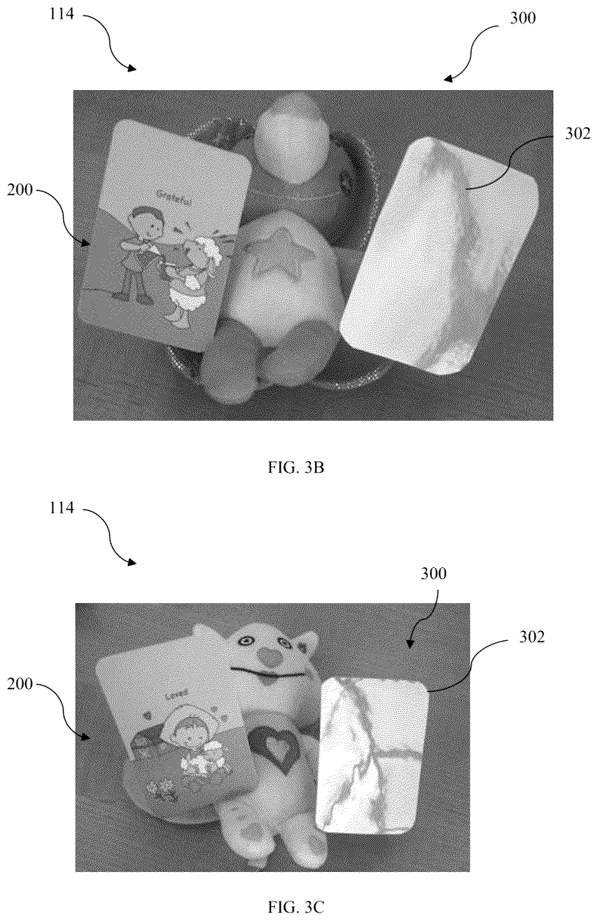

FIGS. 2A-2C show a front and back view of at least one message card 200, according to an embodiment of the present disclosure. FIGS. 3A-3C show a frontal image of the educational plush toy 100 detachably attached with the at least one message card 200 and at least one mirror card 300, respectively, according to an embodiment of the present disclosure.

In some embodiments, the educational plush toy 100 further comprises the at least one message card 200 configured to be detachably attached to the at least one paw 108A of the arm 106A via the first attachment element. In some embodiments, the at least one message card 200 may include a visual affirmation. In some embodiments, the visual affirmation comprises positive, emotionally supportive statements to promote self-awareness, emotional expression, and psychological well-being to the user. In some embodiments, the visual affirmation are positive statements or happy self-talk messages designed to help reprogram user's subconscious mind and create positive change in the user's life. The visual affirmation focuses on self-love, self-acceptance, forgiveness, and attracting positive experiences. Further, the visual affirmation may correspond to a message or statement printed, displayed, or otherwise represents on surface of the at least one message card. In some embodiments, the visual affirmation comprises positive, emotionally supportive statements intended to promote self-awareness, emotional expression, and psychological well-being in the user.

In one example embodiment, the visual affirmation may include at least “I am brave”, “I am loved”, “My feeling matter” etc. In another example, the visual affirmation may include “I love and approve of myself,” “Life supports me,” and “I am at peace.”. Further, the visual affirmation may include affirmations for self-love and acceptance, for forgiveness, for health and well-being, for life and prosperity, for relationships, for personal growth, and for positive mindset. In some embodiments, the visual affirmation for self-love and acceptance may include at least “I love and approve of myself”, “I deeply love and appreciate myself”, “I am worthy of love and acceptance”, “I am enough just as I am”, “I embrace my uniqueness and celebrate my individuality”, “I accept myself unconditionally”, and “I am confident in my own skin”.

Further, the visual affirmation for forgiveness may include at least “I forgive myself and release the past”, “As I forgive myself, it becomes easier to forgive others”, and “I release all criticism”. Further, the visual affirmation for health and well-being may include at least “I love my body”, “I am in perfect health”, “My happy thoughts help create my healthy body”, “Wellness is the natural state of my body”, and “I listen with love to my body's messages”. Further, the visual affirmation for life and prosperity may include at least “Life supports me”, “I trust the process of life”, “I am at peace”, “Life loves me!”, “I am willing to let go”, “I welcome miracles into my life”, “I am prosperous”, “There is plenty for everyone”, and “All is well in my world”.

Further, the visual affirmation for relationships may include at least “I am loved”, “I love my family members just as they are”, and “I feel tolerance, compassion, and love for all people, myself included”. Further, the visual affirmation for personal growth may include at least “I am in the process of positive change”, “I claim my power and move beyond all limitations”, “I am willing to change”, “I choose to change my thinking”, and “I choose to make today a pleasure to experience”. Further, the visual affirmation for positive mindset may include at least “I choose to feel good about myself”, “I choose to focus on my positive qualities”, “My thoughts are creative”, “The point of power is always in the present moment”, “It's only a thought, and a thought can be changed”, and “I am filled with joy”.

In some embodiments, the visual affirmation allows the educational plush toy 100 to support therapeutic or educational outcomes, particularly in the children, by reinforcing positive self-concepts and emotional literacy. In one example, the visual affirmation may enable the user to look in the mirror and say I feel peaceful when I see a puppy sleeping and infers I am happy when I see a puppy sleeping in one of the visual affirmation on the at least one message card 200. Further, the at least one message card 200 comprises a first side 202 and a second side 204. In some embodiments, the first side 202 indicates a positive character image 206 and text for illustrating various behaviors to the user, as shown in FIGS. 2A and 2B. In some embodiments, the second side 204 indicates a visual affirmation text 208 (also referred as visual affirmation) and instructional guidance to be practiced by the user FIGS. 2A and 2C. In one example embodiment, the visual affirmation text 208 is “think of a time when you felt happy, maybe you laughed so hard that your tummy felt tickly!” and “Say this HappyCoo: I feel happy when I walk into a room and surprise, there's a party just for me!”.

The first side 202 of the at least one message card 200, in one aspect, provides a positive character image and word for illustrating various behaviors. The back side of the message card provides a positive affirmation and instructional guidance to be practiced by the child. The back side of the message card also includes an attachment means (e.g., Velcro) for attaching the card to a paw of the plush. It may be noted that the term user, child and children may be iteratively used in the application, however each of the terms hold similar meaning.

In some embodiments, the at least one message card 200 may be detachably attached to the at least one paw 108A of the arm 106A from the at least two arms 106. Further, the educational plush toy 118 comprises at least one mirror card 300 (as shown in FIGS. 3A-3C) configured to be detachably attached to at least one paw 108B of another arm 106B of the at least two arms 106 via the first attachment element. In some embodiments, the at least one mirror card 300 includes a reflective surface 302. In some embodiments, the educational plush toy 100 or the educational plush toy 118 are constructed and arranged such that the user is enabled to view their own reflection in the reflective surface 302 of the at least one mirror card 300 while reading or hearing the visual affirmation displayed over the at least one message card 200. In some embodiments, one arm 106A of the at least two arms 106 may be detachably attached with the at least one message card 200 and another arm 106B of the at least two arms 106 may be detachably attached with the at least one mirror card 300.

In one example embodiments, a five-year-old child named Mia is experiencing anxiety on her first day at a new preschool. Mia's caregiver presents her with an educational plush toy 100 equipped with the at least one message card 200 and the at least one mirror card 300 attached to each paw 108A and 108B respectively. On the left paw i.e., the at least one paw 108B, the at least one mirror card 300 is affixed, allowing Mia to see her reflection. On the right paw, i.e., the at least one paw 108A, the at least one message card 200 is attached, displaying the message: “You are brave.”. Mia is encouraged to hold the educational plush toy 118 in front of her, look into the at least one mirror card 300, and say the affirmation aloud. As she repeats the phrase “You are brave” while looking at herself, she begins to calm down.

In one example, the child looks into the at least one mirror card 300 and says happy and smiles. Caregiver reads back of the at least one message card 200. Child says I feel happy when I walk into a room and surprise there's a party just for me. This practice not only distracts Mia from her anxiety but also helps her internalize a positive message. In another example, the at least one message card 200 is attached, displaying the message: “Happy” as shown in FIG. 3A or “Grateful” as shown in FIG. 3B or “Loved” as shown in FIG. 3C. The emotional mirroring technique, supported by the interactive design, reinforces her self-confidence and provides comfort during an emotionally challenging moment.

Further, each of the at least one message card 200 and the at least one mirror card 300 comprises a second attachment element (not shown) configured to detachably attach with a corresponding first attachment element to detachably attach the at least one message card 200 and the at least one mirror card 300 to the at least one paw 108 of the corresponding arm. In some embodiments, the educational plush toy 100 and the educational plush toy 118 is designed to replicate and assist in teaching positive emotions such as peace, love, and kindness, and be a comforting companion to the child. Moreover, the at least one message card 200 and the at least one mirror card 300 allow the child to see, say, and express the emotion presented, i.e., exploring an emotion and mirroring the presented feeling/emotion with the mirror.

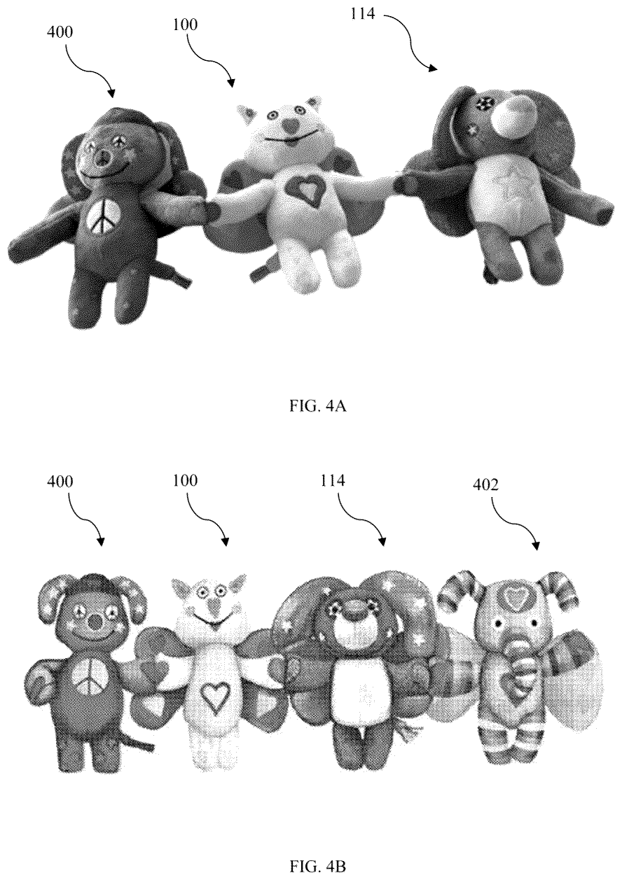

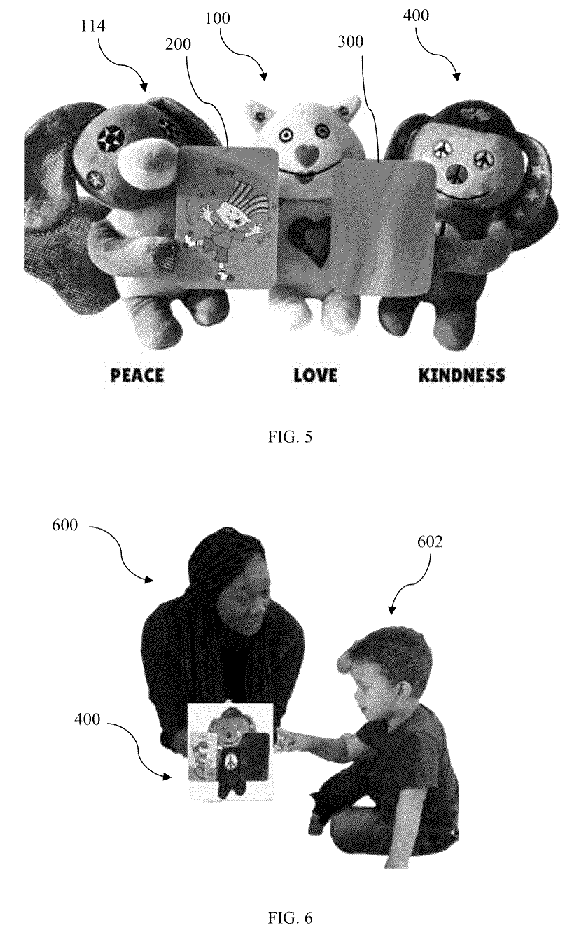

FIGS. 4A-5 illustrates how the user or child may combine teachings of peace, love, and kindness by attaching the educational plush toy 100, the educational plush toy 118 and another educational plush toy 400 of different designs, according to an embodiment of the present disclosure. FIG. 6 illustrates the user engaging with the child using the educational plush toy 100.

In some embodiments, the education plush toy 100 is configured to detachably couple in a series to the educational plush toy 118 and the another educational plush toy 400 (as shown in FIG. 4A), by detachably attaching the first attachment element with a corresponding attachment element on each of the one or more education plush toys. In some embodiments, such configuration allows one or more education plush toys to be connected end to end with the educational plush toy 100, facilitating group interaction, modular educational activities, or expanded emotional support systems. As described above, the first attachment elements may comprise at least one of the Velcro, magnets, snaps, or other reusable fastening means that enable secure yet easily releasable connection between another education plush toys 400 and the educational plush toy 100. In another embodiment, the education plush toy 100 is configured to detachably couple in a series to the educational plush toy 118, the another educational plush toy 400, and another educational plush toy 402 (as shown in FIG. 4B) by detachably attaching the first attachment element with a corresponding attachment element on each of the one or more education plush toys.

Further, the educational plush toy 100 may be configured to display or indicate the one or more emotions to the user. In an aspect, a peace educational plush toy design i.e. the educational plush toy 118 is used to illicit a calming feeling in the child, as shown in FIG. 5. The piece educational plush toy design teaches that it takes time to understand why someone is acting a certain way and that by emulating Peace the child is taught not to raise their voice. It may be noted that peace has silky ears and embroidered peace signs and wings for the child to use to pretend peace is flying. The arms and legs are positionable. And each paw has half a heart that when they put their hands together with each other or their own paw forms a whole heart.

Likewise, a Kindness educational plush toy design i.e. the educational plush toy 400 is used to teach thoughtfulness and caring for other's [children's] feelings, as shown in FIG. 5. Further, it is used in teaching friendliness, compassion, and doing nice things for others without expecting something in return. It may be noted that kindness has silky floppy ears a soft snout that children may rub noses with and wings they can use to pretend they fly. The arms and legs are positionable. And their paws each have half a heart that when they put their hands together with each other or their own paw forms a whole heart.

Further, a Love educational plush toy design i.e. the educational plush toy 100 is used to bring comfort and joy to others by teaching children to love themselves by showing kindness and understanding for themselves and those in their company, as shown in FIG. 5. It may be noted that Love has a heart on its chest, mouth, ears and many on his wings for the child to use to pretend Love is flying. The arms and legs are positionable. And their paws each have half a heart that when they put their hands together with each other or their own paw forms a whole heart.

In an exemplary embodiment as shown in FIG. 6, a parent 600 presents the educational plush toy 400 for teaching “Calm”, wherein a child 602 i.e. the user views himself in the at least one mirror card 300 and repeats the affirmation written on the back side of the at least one message card 200, or as guided by the parent 600. Additional embodiments of the present disclosure are discussed below. Each of the embodiments may be made possible with the use of one or more plush (said plush configured with an attachment means), an affirmation card (message card), and a mirrored card.

In an embodiment, reinforced habits of happiness through emotional mirroring techniques is taught to children using a plush, affirmation card (message card), and mirrored card (the system). In an aspect, the educational plush toy 100 is designed to help children explore and express their feelings using emotional mirroring techniques. Further, the child's engagement with the system, particularly through the mirrored card, provides an interactive plush that makes emotional learning fun and engaging.

In another aspect, the educational plush toy 100 of various distinct designs characterize, for example, Peace, Love, and Kindness, wherein the Peace design teaches mindfulness and calm communication, the Love design nurtures self-acceptance and lifelong friendships, and the Kindness design inspires caring actions and thoughtfulness. In an embodiment, the educational plush toy 100 helps children recognize and regulate emotions, and reinforces positive self-expression through fun, hands-on play. The educational plush toy 100 also encourages connection and empathy, making emotional learning second nature.

In an embodiment, the use of the educational plush toy 100, the at least one message card 200, and the at least one mirror card 300 i.e. collectively termed as a system, shapes the happiness of children by managing their thoughts through the words they use to see themselves. In an exemplary aspect, the system provides an educational method to teach children how to feel happy. For example, and more specifically, the child engages with the system by reading (or having said to them) positive affirmations as depicted on the at least one message card 200 affixed to one or more plush, while looking at themselves in the mirrored card and repeating the affirmation. More specifically, in an exemplary aspect, the system provides a practice that over time makes happiness for the child a natural habit leading to their continued joy, confidence, emotional resilience, and positive self-image. The practice comprises: the at least one message card 200 and the at least one mirror card 300 being affixed to the system, presenting a child with the system and encouraging them to view themselves in the mirrored card while repeating the affirmations on an affirmation card (i.e., the at least one message card 200); and encouraging the child to repeat the process frequently to instill positive, happy thoughts. In an embodiment, the system provides means for allowing users and/or children to create their own affirmations using positive words that start with, for example, “I can” (e.g., “I can be kind to myself.”); “I am” (e.g., “I am loved.”); “I do” (e.g., “I do things that make me happy.”); and “I have” (e.g., “I have people who care about me.”).

In some embodiments, the educational plush toy 100 further comprises one or more sensors integrated within a plurality of locations as shown by the arrows 114 in FIG. 1A, of the body portion 102, each of the one or more sensors are configured to detect a touch input of the user. In some embodiments, the one or more sensors comprises at least one of a touch sensor, pressure sensor, resistive touch sensor pads or other suitable sensor capable of identifying physical interaction with the educational plush toy 100. In some embodiments, placement of the one or more sensors may vary depending on the design and intended interaction zones of the educational plush toy 100 and the plurality of locations may correspond to at least the paws, belly, back, or head. The integration of the one or more sensors enables the educational plush toy 100 to respond dynamically to the user engagement, promoting interactive learning.

Further, the body portion 102 further comprises at least one speaker integrated within the plurality of locations as shown by the arrows 116 in FIG. 1A, and operatively coupled to each of the one or more sensors, the at least one speaker is configured to provide an audio feedback or interactive response to the user based at least on the detected touch input. In some embodiments, the plurality of locations may correspond to at least the paws, belly, back, or head. In one example embodiment, when the user touches a designated sensor of the one or more sensors, the at least one speaker may play a prerecorded affirmation, comforting phrase, language-learning cue, or instructional prompt. The prerecorded affirmation may be incorporated with different languages to teach basic vocabulary.

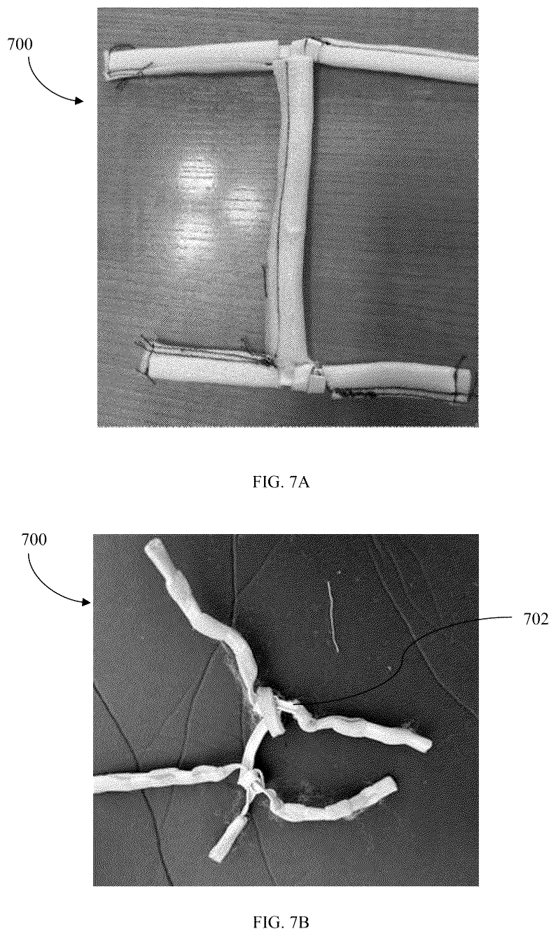

FIGS. 7A-7B shows a frame 700 for the educational plush toy 100, according to an embodiment of the present disclosure.

In some embodiments, the frame 700 corresponds to an interior structure of the educational plush toy 100 and may be configured to provide structural rigidity to the educational plush toy 100. In some embodiments, the frame 700 is formed with wire material surrounded by a cushion material for forming the educational plush toy 100, further the frame 700 also comprises elastic material 702 to provide flexibility to the frame 700, as shown in FIG. 7B. In some embodiments, the wire material may be formed of a bendable material. As discussed in FIG. 1A, the arm 106A may have at least one paw 108A and another arm 106B may have at least one paw 108B. Each of the at least one paw 108A and the at least one paw 108B may be positioned together to form a heart shape. In some embodiments, the wire material may be configured to allow the at least one paw 108A and the at least one paw 108B to be remain in a stationary position.

In some embodiments, the frame 700 may form an “I” shape as shown in FIGS. 7A-7B. The frame 700 may be composed of a lightweight, durable material such as plastic, foam, or a flexible polymer, and may be embedded within the stuffing material or sewn into an internal lining. In some embodiments, the “I” shape may extend vertically along the central axis of the body portion, providing core support while leaving the at least two arms and outer portions flexible. The frame helps maintain the upright posture or intended shape of the plush toy, especially when positioned for display, interaction, or during attachment of accessories.

FIG. 8 illustrates a block diagram 800 showing communication between one or more sensors 802 and at least one speaker 804, according to an embodiment of the present disclosure.

In some embodiments, the educational plush toy 100 further comprises one or more sensors 802 integrated within a plurality of locations as shown by the arrows 114 shown in FIG. 1A, of the body portion 102, each of the one or more sensors 802 are configured to detect a touch input of the user. In some embodiments, the one or more sensors 802 comprises at least one of a touch sensor, pressure sensor, resistive touch sensor pads or other suitable sensor capable of identifying physical interaction with the educational plush toy 100. In some embodiments, placement of the one or more sensors 802 may vary depending on the design and intended interaction zones of the educational plush toy 100 and the plurality of locations may include at least the paws, belly, back, or head. The integration of the one or more sensors 802 enables the educational plush toy 100 to respond dynamically to the user engagement, promoting interactive learning.

Further, the body portion 102 further comprises at least one speaker 804 integrated within the plurality of locations as shown by the arrows 116 in FIG. 1A, and operatively coupled to each of the one or more sensors 802, the at least one speaker 804 is configured to provide an audio feedback or interactive response to the user based at least on the detected touch input. In some embodiments, the plurality of locations may include at least the paws, belly, back, or head. In one example embodiment, when the user touches a designated sensor of the one or more sensors 802, the at least one speaker 804 may play a prerecorded affirmation, comforting phrase, language-learning cue, or instructional prompt. The prerecorded affirmation may be incorporated with different languages to teach basic vocabulary.

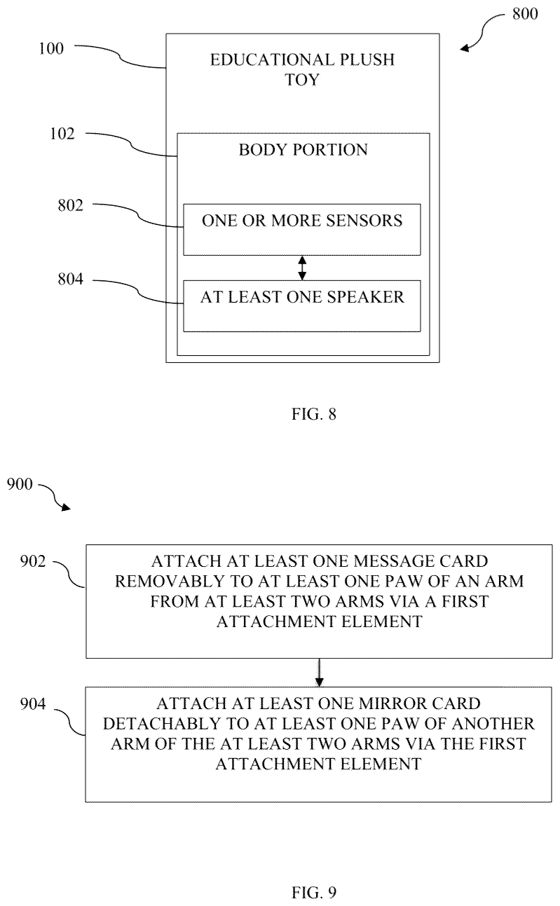

FIG. 9 illustrates a flowchart showing a method 900 for providing emotional wellness to the user, according to an embodiment of the present disclosure.

At step 902, at least one message card 200 is detachably attached to the at least one paw 108A of an arm 106A from the at least two arms 106 via the first attachment element, the at least one message card 200 including a visual affirmation.

In some embodiments, the educational plush toy 100 further comprises the at least one message card 200 configured to be detachably attached to the at least one paw 108A of the arm 106A from the at least two arms 106A and 106B via the first attachment element. In some embodiments, the at least one message card 200 may include a visual affirmation. In some embodiments, the visual affirmation comprises positive, emotionally supportive statements to promote self-awareness, emotional expression, and psychological well-being to the user. In some embodiments, the visual affirmation may correspond to a message or statement printed, displayed, or otherwise represents on surface of the at least one message card. In some embodiments, the visual affirmation comprises positive, emotionally supportive statements intended to promote self-awareness, emotional expression, and psychological well-being in the user.

At step 904, at least one mirror card 300 is detachably attached to at least one paw 108B of another arm 106B of the at least two arms 106 via the first attachment element, the at least one mirror card including a reflective surface.

Further, the educational plush toy 100 comprises at least one mirror card 300 configured to be detachably attached to at least one paw 108B of another arm 106B of the at least two arms 106 via the first attachment element. In some embodiments, the at least one mirror card 300 including the reflective surface 302. In some embodiments, the educational plush toy 100 is constructed and arranged such that the user is enabled to view their own reflection in the reflective surface 302 of the at least one mirror card 300 while reading or hearing the visual affirmation displayed over the at least one message card 200.

In one embodiment, each day, the children may be encouraged to look in the at least one mirror card 300 and say “I can . . . (e.g., “I can be kind to myself.”), I am . . . (e.g., “I am loved.”), I do . . . (e.g., “I do things that make me happy.”), and I have . . . (e.g., “I have people who care about me.”). By repeating these positive words, children start to feel the happiness they speak because when thinking about happy thoughts, happy feelings are created. Over time, this simple practice makes joy a natural habit, helping your child build emotional resilience and a positive self-image.

In some embodiments, the educational plush toy 100 may be used for teaching self-love skills where children may choose words that express what they love about themselves by choosing them from a pile of positive adjustives and placing them onto Velcro enabled at least one paw 108A and at least one paw 108B. Further, friendship skills are taught using the educational plush toy 100. Children choose words to express that they like/love about their friends by choosing them from a pile of positive adjectives and placing them onto the at least one paw 108A and at least one paw 108B. Further, the educational plush toy 100 teaches children how to move from feeling anxious to feeling calm. This is accomplished by using charts of the calibrated energy of our emotional vibrations to help children learn how their body's energy moves from anxious to calm levels.

Further, the educational plush toy 100 is used to teach mathematics by helping in counting, adding and subtracting numbers by placing numbers on the at least one paw 108A and at least one paw 108B that stick numbers on hands 1+1=2. The number form and word form for number recognition is provided on Velcro dots used to stick numbers on at least one paw 108A and at least one paw 108B. The educational plush toy 100 also may enable to taught motor skills by putting hands of the plush together and pulling them apart and putting them together with other educational plush toys and pulling them apart. The alphabets may also be learned by having children match Velcro backed pictures and letters y sticking them to the hands. For example, a picture of a car and letter C can be implemented or a picture of a car and the word “car” may be implemented.

Further, secret messages may be implemented for example, the message I (picture of heart U written in invisible ink and stuck to the hand of the educational plush toy 100. Children may use UV light to read the message. The UV light pen may be additionally be attached to a hand of the educational plush toy 100. Further, setting a table may be taught by removable attaching utensils on the hands of the educational plush toy 100. For example, Velcro enabled fork on one hand and knife on another. Further, days, week may be taught for example, “Today is ---” may be stuck on one hand. A child may put correct day of the week on another hand.

While there is shown and described herein certain specific structures embodying various embodiments of the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims. For example, external plates, such as the pendant front and back plates may be connected to internal securing plates (e.g., front plate and back plate caps) in various ways not explicitly described. Additionally, elements as shown in the drawings, though not specifically mentioned in the present disclosure still comprise elements of the invention.

What is claimed is:

1. An educational plush toy for emotional wellness of a user, the educational plush toy comprising:
a body portion comprising:
at least two arms, wherein each arm terminating to at least one paw;
a first attachment element positioned on each of the at least one paw;
at least one message card configured to be detachably attached to the at least one paw of an arm from the at least two arms via the first attachment element, wherein the at least one message card including a visual affirmation;
at least one mirror card configured to be detachably attached to at least one paw of another arm of the at least two arms via the first attachment element, wherein the at least one mirror card including a reflective surface,
wherein the educational plush toy is constructed and arranged such that the user is enabled to view their own reflection in the reflective surface of the at least one mirror card while reading or hearing the visual affirmation displayed over the at least one message card.

2. The educational plush toy of claim 1, wherein each of the at least one message card and the at least one mirror card comprises a second attachment element configured to detachably attach with a corresponding first attachment element to detachably attach the at least one message card and the at least one mirror card to the at least one paw of the corresponding arm.

3. The educational plush toy of claim 2, wherein the first attachment element and the second attachment elements correspond to at least one of a Velcro, magnets, snaps, or other reusable fastening elements.

4. The educational plush toy of claim 1, wherein the at least one message card comprises a first side and a second side, wherein the first side indicates a positive character image and text for illustrating various behaviors to the user, and the second side indicates the visual affirmation and instructional guidance to be practiced by the user.

5. The educational plush toy of claim 1, wherein the visual affirmation comprises positive, emotionally supportive statements to promote self-awareness, emotional expression, and psychological well-being to the user.

6. The educational plush toy of claim 1, further comprises a face portion coupled to the body portion, wherein the face portion includes a facial expression indicator configured to represent one or more emotions to the user, wherein the one or more emotions comprises at least one of a peace, love, and happiness.

7. The education plush toy of claim 1, wherein the education plush toy is configured to detachably couple in a series to another one or more education plush toys by detachably attaching the first attachment element with a corresponding attachment element on each of the one or more education plush toys.

8. The educational plush toy of claim 1, wherein the body portion further comprises one or more sensors integrated within a plurality of locations of the body portion, wherein each of the one or more sensors are configured to detect a touch input of the user.

9. The educational plush toy of claim 8, wherein the body portion further comprises at least one speaker operatively coupled to each of the one or more sensor, wherein the at least one speaker is configured to provide an audio feedback or interactive response to the user based at least on the detected touch input.

10. The educational plush toy of claim 1, further comprising one or more accessories configured to be removably attached to the at least one paw, wherein the one or more accessories are configured to teach health and hygiene, environmental awareness, safety skills, language learning, and storytelling to the user.

11. A method comprising:
attaching at least one message card removably to at least one paw of an arm from at least two arms via a first attachment element, wherein the at least one message card including a visual affirmation, and each arm termination to the at least one paw; and
attaching at least one mirror card detachably to at least one paw of another arm of the at least two arms via the first attachment element, wherein the at least one mirror card including a reflective surface,
wherein the educational plush toy is constructed and arranged such that the user is enabled to view their own reflection in the reflective surface of the at least one mirror card while reading or hearing the visual affirmation displayed over the at least one message card.

12. The method of claim 11, wherein each of the at least one message card and the at least one mirror card comprises a second attachment element configured to detachably attach with a corresponding first attachment element to detachably attach the at least one message card and the at least one mirror card to the at least one paw of the corresponding arm.

13. The method of claim 12, wherein the first attachment element and the second attachment elements correspond to at least one of a Velcro, magnets, snaps, or other reusable fastening elements.

14. The method of claim 11, wherein the at least one message card comprises a first side and a second side, wherein the first side indicates a positive character image and text for illustrating various behaviors to the user, and the second side indicates the visual affirmation and instructional guidance to be practiced by the user.

15. The method of claim 11, wherein the visual affirmation comprises positive, emotionally supportive statements to promote self-awareness, emotional expression, and psychological well-being to the user.

16. The method of claim 11 further comprising representing, via a face portion coupled to the body portion, one or more emotions to the user using a facial expression indicator, wherein the one or more emotions comprises at least one of a peace, love, and happiness.

17. The method of claim 11 further comprising coupling, the education plush toy in a series to another one or more education plush toys by detachably attaching the first attachment element with a corresponding attachment element on each of the one or more education plush toys.

18. The method of claim 11 further comprising detecting, via one or more sensors integrated within a plurality of locations of the body portion, a touch input of the user.

19. The method of claim 18 further comprising providing, via at least one speaker operatively coupled to each of the one or more sensor, an audio feedback or interactive response to the user based at least on the detected touch input.

20. The method of claim 11 further comprising teaching, via one or more accessories removably attached to the at least one paw, health and hygiene, environmental awareness, safety skills, language learning, and storytelling to the user.
